(19) United States
(12) Patent Application Publication
(10) Pub. No.: US 2007/0125315 A1
(43) Pub. Date: Jun. 7, 2007

(54) Child safety device

(76) Inventor: Nancy Vardalos Ginakes, Winnipeg (CA)

Correspondence Address: Ade & Company Inc., 1795 Henderson Highway, PO Box 28006, Winnipeg, Manitoba, R2G 4E9, CA

(21) Appl. No.: 11/445,282

(22) Filed: Jun. 2, 2006

(30) Foreign Application Priority Data
Dec. 1, 2005 (CA) 2,259,858

(51) Int. Cl. A01K 27/00

(52) U.S. Cl. 119/770

(57) ABSTRACT

A child safety device tethers a child to an adult using an attachment mechanism about a torso of the child and an anchor for being carried by the adult which are joined by a tether. A first decorative item disguises the attachment mechanism and a second decorative item disguising the anchor. The anchor is selectively storable within a hollow interior of the second decorative item. The attachment mechanism comprises a harness which carries a reel for winding the tether thereon and which includes shoulder straps for extending over the shoulders of the child for adequately supporting the reel and first decorative item on the back of the child without obstructing the child's normal movement.

This application claims foreign priority benefits from Canadian Patent Application 2,259,858 filed Dec. 1, 2005.

### FIELD OF THE INVENTION

The present invention relates to a child safety device, and more particularly relates to a device for tethering a child to an adult.

### BACKGROUND

The use of a tether between a parent and child is known to prevent children from wandering too far from a parent and accordingly prevent the child from being lost.

U.S. Pat. No. 5,638,772 to Kaufmann et al discloses an example of a tether for being coupled between a child and adult. A first belt is secured about the child and supports a reel thereon upon which a tether is wound. A first toy surrounds and disguises the reel. At an opposing end of the tether, a second belt is provided for securement about the waist of the adult. A second toy is coupled to the belt for covering the second end of the tether. This device however is particularly uncomfortable for the child which must carry the large bulky weight of the reel about their waist. Furthermore the attachment to the adult is similarly large and bulky so as to act as an obstruction to normal walking motion. The waist belt is poorly disguised because the toy used for decoration is coupled between the tether and the belt.

### SUMMARY OF THE INVENTION

According to one aspect of the invention there is provided a child safety device for tethering a child to an adult, the device comprising:

an attachment mechanism for securement about a torso of the child;

a first decorative item secured to the attachment mechanism for disguising the attachment mechanism;

an anchor for being carried by the adult;

a tether having a first end coupled to the attachment mechanism and a second end connected to the anchor; and

a second decorative item attached to the anchor for disguising the anchor;

the second decorative item being arranged for being selectively supported on the first decorative item; and

the anchor being selectively storable within a hollow interior of the second decorative item.

When not in use, the function of the child safety device can readily be disguised by storing the second decorative item on the first decorative item and in turn storing the anchor within the second decorative item.

According to a second aspect of the present invention there is provided a child safety device for tethering a child to an adult, the device comprising:

an attachment mechanism for securement about a torso of the child;

a first decorative item secured to the attachment mechanism for disguising the attachment mechanism;

an anchor for being carried by the adult;

a tether having a first end coupled to the attachment mechanism and a second end coupled to the anchor; and

a second decorative item attached to the anchor for disguising the anchor;

the attachment mechanism comprising a harness including shoulder straps for extending over the shoulders of the child.

By providing a harness having shoulder straps for securement over shoulders of the child, the associated decorative item and any reel associated therewith can be comfortably carried on the back of the child without obstructing the child's normal movement.

The anchor may comprise a loop having a prescribed diameter which is suitably sized for being supported about a wrist of the adult. The loop may be formed of flexible material.

There may be provided an opening in the second decorative item for receiving the anchor selectively therethrough and wherein there is provided a closure member on the second decorative item for selectively enclosing the opening.

The attachment mechanism preferably comprises a harness including shoulder straps for extending over the shoulders of the child. The attachment mechanism preferably includes a reel for winding the tether thereon in which the reel is disguised by the first decorative item and in which the reel is carried by the harness for positioning adjacent a back of the child.

When the reel is biased in a winding direction for winding the tether onto the reel, preferably there is provided a lock mechanism which selectively restricts rotation of the reel in the winding direction.

A release button for selectively releasing the lock mechanism is preferably located adjacent a rear side of the first decorative item, opposite the harness.

Preferably, the first decorative item is plural times larger than the second decorative item for disguising the reel.

Some embodiments of the invention will now be described in conjunction with the accompanying drawings in which:

### BRIEF DESCRIPTION OF THE DRAWINGS

FIG. 1 is a schematic view of the components of the child safety device.

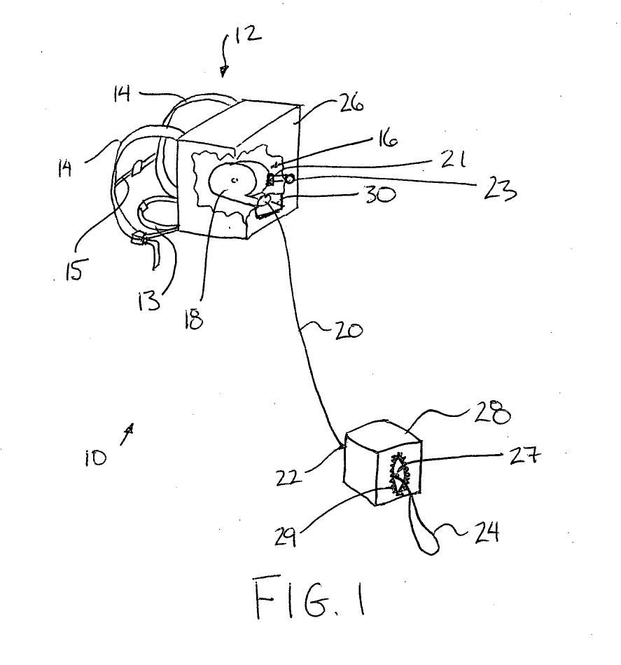

FIGS. 2 and 3 illustrate a first embodiment of the decorative items on the child safety device in the retracted and extended positions of the tether respectively.

FIGS. 4 and 5 illustrate a second embodiment of the decorative items on the child safety device in the retracted and extended positions of the tether respectively.

FIGS. 6 and 7 illustrate a third embodiment of the decorative items on the child safety device in the retracted and extended positions of the tether respectively.

FIGS. 8 and 9 illustrate a fourth embodiment of the decorative items on the child safety device in the retracted and extended positions of the tether respectively.

FIGS. 10 and 11 illustrate a fifth embodiment of the decorative items on the child safety device in the retracted and extended positions of the tether respectively.

In the drawings like characters of reference indicate corresponding parts in the different figures.

### DETAILED DESCRIPTION

Referring to the accompanying figures there is illustrated a child safety device generally indicated by reference numeral 10. The device 10 is particularly suited for tethering a child to an adult, for example a parent or guardian.

The device 10 includes an attachment mechanism 12 in the form of harness for securement about a torso of the child. The harness includes two shoulder straps 14 which are adjustable in length for being snugly secured about the shoulders of the child similarly to a conventional backpack and a chest strap 15 for joining the shoulder straps across a chest of the child. A waist strap 13 is also provided for securement about the waist of the child. The harness carries a storage chamber 16 on the back of the child to which the shoulder straps 14 are attached.

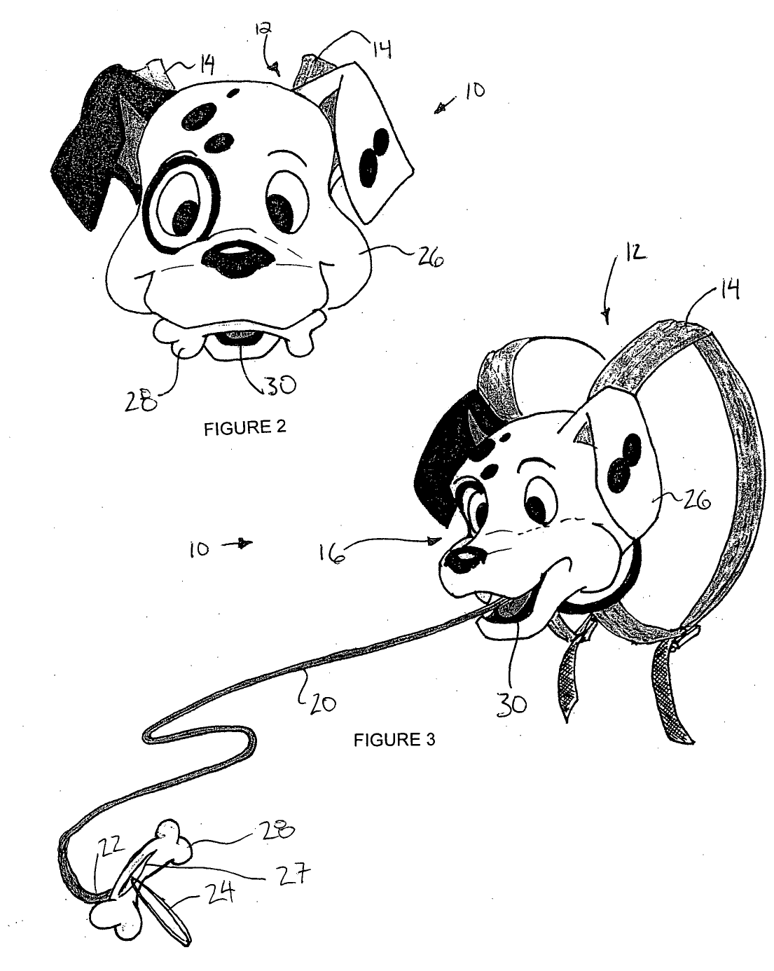

A reel 18 is supported within the chamber 16 and supports a tether 20 thereon. The tether is anchored at its first end on the reel of the attachment mechanism so that the tether may be wound onto the reel from an extended position in which a second end 22 of the tether is spaced apart from the reel and the tether is at least partly unwound from the reel as shown in FIG. 3, and a retracted position in which the second end of the tether is adjacent the reel and the tether is substantially fully wound on the reel as shown in FIG. 2. The reel is configured to be biased in a winding direction for winding the tether onto the reel into the retracted position. An automatic lock mechanism 21 selectively restricts rotation of the reel in the winding direction to retract the tether until a release button 23 is depressed for selectively releasing the automatic lock.

The second end 22 of the tether 18 is coupled to an anchor 24. The anchor 24 comprises a loop of flexible material, for example elastic, but which has a fixed prescribed diameter in an unstretched position thereof. The loop is suitably sized for being supported about a wrist of the adult in use and accordingly has a preferred internal diameter of 3 to 4 inches.

A first decorative item 26 is supported on the harness of the attachment mechanism for disguising both the harness and more particularly for disguising the reel supported within the storage chamber 16 thereof. The first decorative item 26 generally comprises a plush toy which is suitable stuffed with resilient material to provided a soft and aesthetically pleasing toy for the child to play with when the harness is removed from a child.

A second decorative item 28 is supported on the second end 22 of the tether 18 and serves to couple the anchor 24 to the tether. The first decorative item 26 is plural times larger then the second decorative item which is intended to be blended into the first decorative item when supported thereon. The second decorative item 28 includes an internal storage area 27 defined by a hollow interior of the item and which is accessible through an opening having a closure member 29 for selectively closing the opening. The anchor 24 is connected to the tether internally within the internal storage area 27 so that the anchor 24 can be stored in the area and enclosed therein by the closure member 29 as desired.

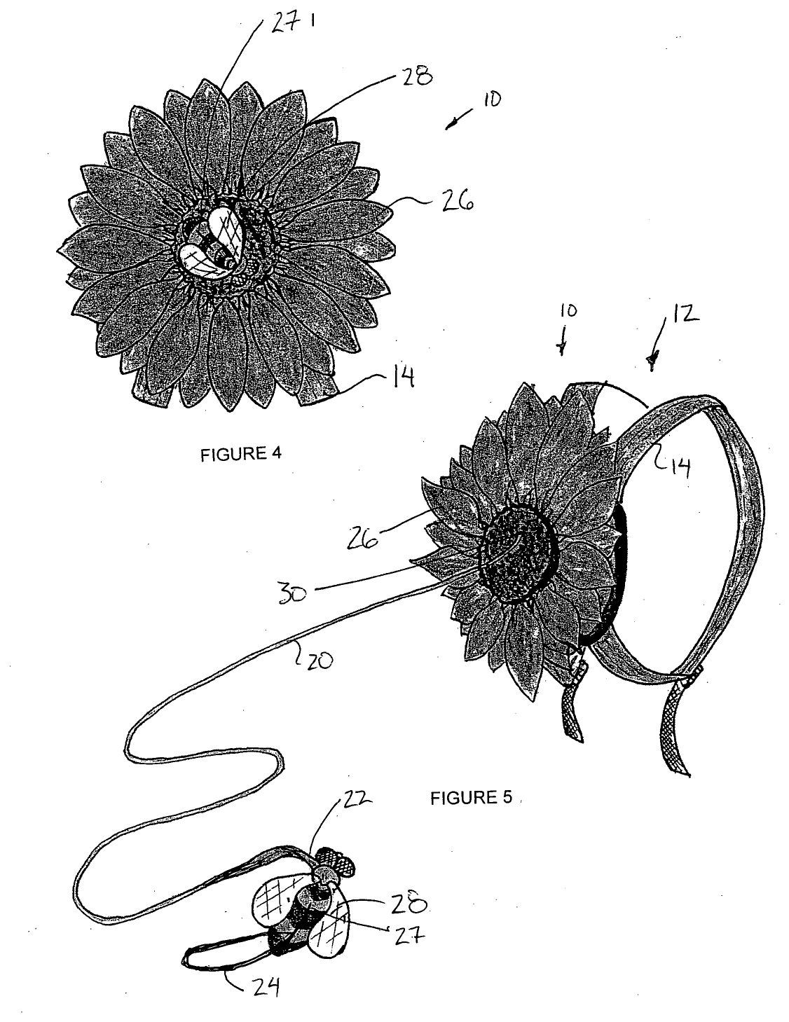

The first and second decorative items have a matching theme but differ in particular design. The second item 28 in particular is much smaller but remains compatible with the design of the first item. As shown in FIGS. 2 and 3, the second decorative item comprises a dog bone which is received within the mouth of a dog forming the first decorative item so that second decorative item is blended into and disguised on the surface of the first decorative item in the retracted position of the tether. In the example of FIG. 4 and 5, the first item comprises a bumble bee for being disguised in a perching position on a flower forming the first decorative item.

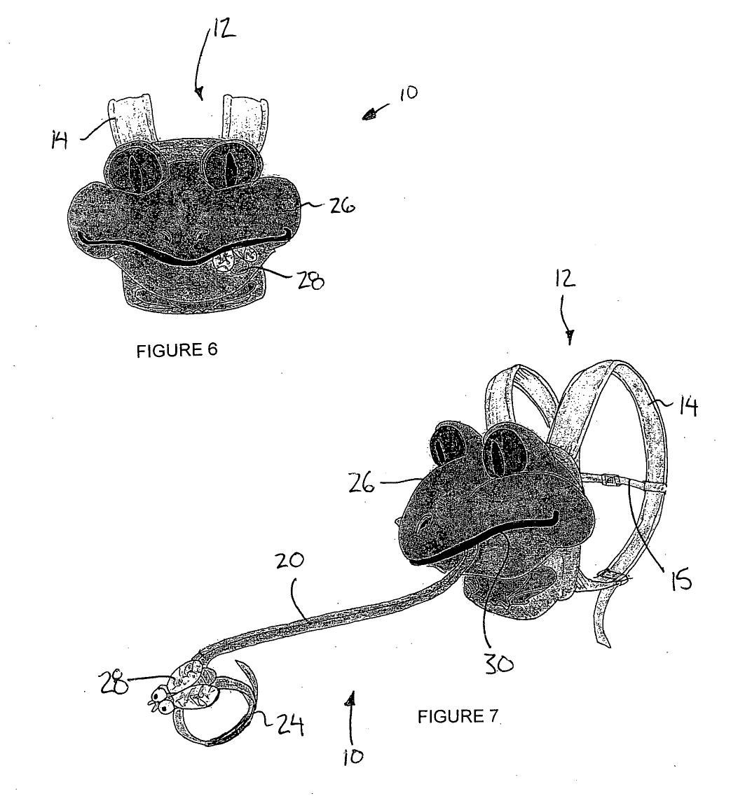

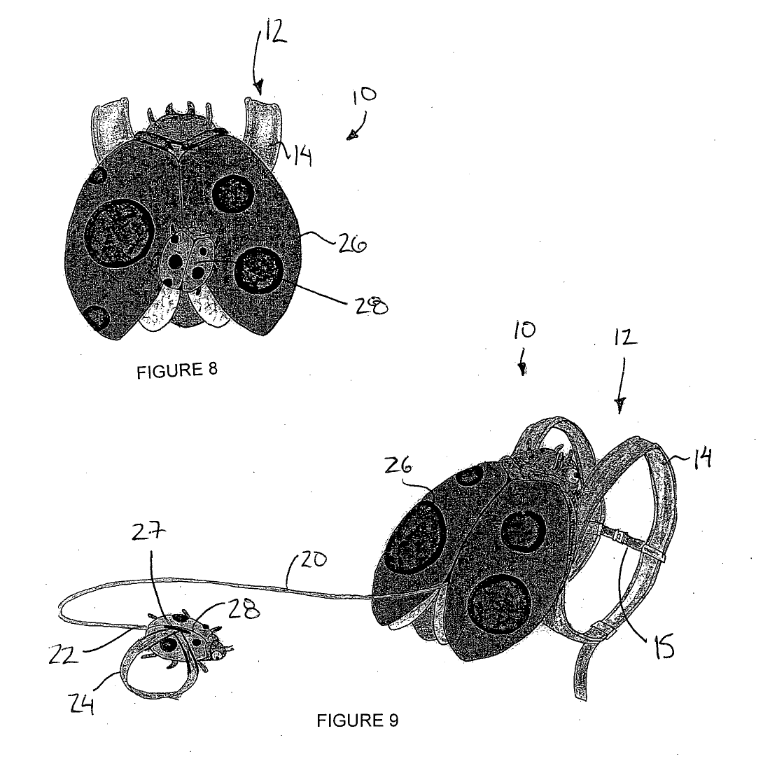

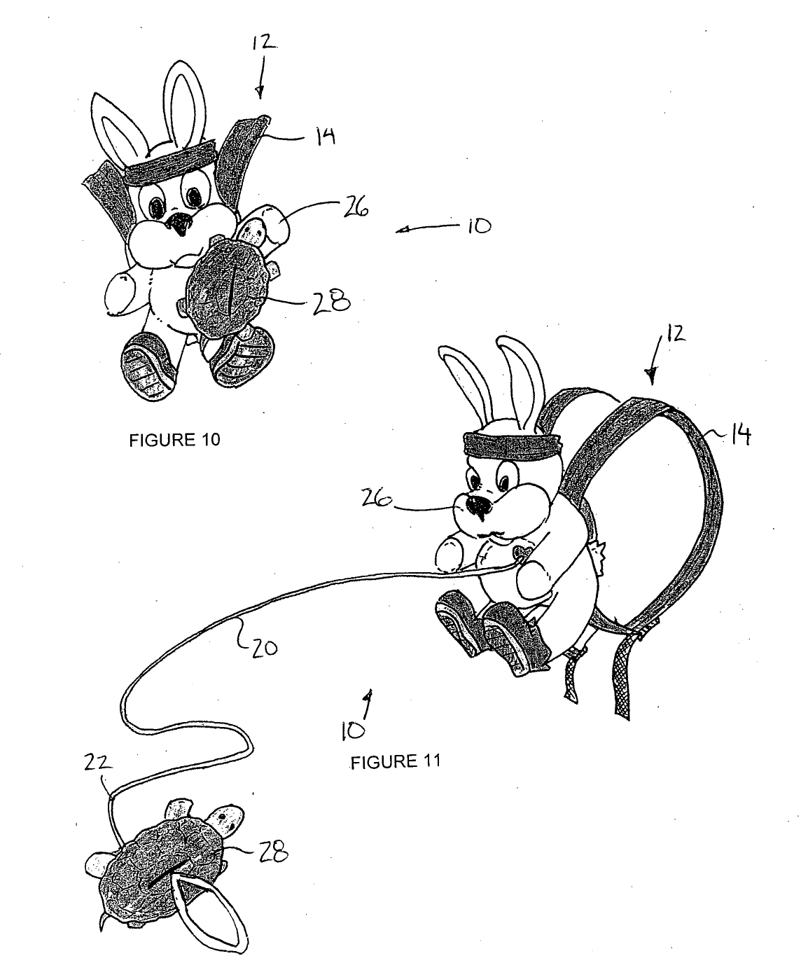

As shown in further examples, in FIGS. 6 and 7, the second decorative item comprises a fly which is retracted into the mouth of a frog comprising the first decorative item. In this instance, the tether may also be disguised as a frog's tongue. As shown in FIGS. 8 and 9, the second decorative item may comprise a smaller version of the first decorative item to resemble a similar parent and child combination, but representative of animals or insects instead. As shown in a further example in FIGS. 10 and 11, the first and second decorative items may instead comprise two types of animals which are known to be in a similar children's tale, for example the turtle and the hare.

In use, the harness of the attachment mechanism 12 is secured about the torso of the child by extending the shoulder straps 14 over the shoulders of the child and tightening the straps in a manner similar to a conventional backpack. The first decorative item and the reel received therein are supported on the back of the child with the tether initially wound onto the reel in a retracted position. In the retracted position, a portion of the second decorative item is received within a mating recess 30 of the first decorative item so that the tether is fully covered by the first decorative item in the retracted position. The second decorative is thus disguised within the first decorative item by blending onto the surface thereof due to the compatible nature of the disguises of the first and second decorative items. Storing the anchor 24 within the internal storage area of the second decorative item further disguises the device when not in use.

When it is desired to tether the child to the adult, the adult simply pulls the second decorative item away from the first decorative item and the anchor 24 is removed from the internal storage area of the second decorative item. The adult grasps the second end of the tether or the second decorative item to remain tethered to the child. If desired the adult may position their wrist through the loop forming the anchor for added securement to the child. The release button 23 is located adjacent a rear side of the first decorative item, opposite the harness so as to be out the reach of the child.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A child safety device for tethering a child to an adult, the device comprising:
an attachment mechanism for securement about a torso of the child;
a first decorative item secured to the attachment mechanism for disguising the attachment mechanism;
an anchor for being carried by the adult;
a tether having a first end coupled to the attachment mechanism and a second end connected to the anchor; and
a second decorative item attached to the anchor for disguising the anchor;
the second decorative item being arranged for being selectively supported on the first decorative item; and
the anchor being selectively storable within a hollow interior of the second decorative item.

2. The device according to claim 1 wherein the anchor comprises a loop having a prescribed diameter.

3. The device according to claim 2 wherein the loop is suitably sized for being supported about a wrist of the adult.

4. The device according to claim 2 wherein the loop is formed of flexible material.

5. The device according to claim 1 wherein there is provided an opening in the second decorative item for receiving the anchor selectively therethrough and wherein there is provided a closure member on the second decorative item for selectively enclosing the opening.

6. The device according to claim 1 wherein the first decorative item is plural times larger than the second decorative item.

7. The device according to claim 1 wherein the attachment mechanism comprises a harness including shoulder straps for extending over the shoulders of the child.

8. The device according to claim 7 wherein the attachment mechanism includes a reel for winding the tether thereon, the reel being disguised by the first decorative item and the reel being carried by the harness for positioning adjacent a back of the child.

9. The device according to claim 8 wherein the reel is biased in a winding direction for winding the tether onto the reel and wherein there is provided a lock mechanism which selectively restricts rotation of the reel in the winding direction.

10. The device according to claim 9 wherein there is provided a release button for selectively releasing lock mechanism, the release button being located adjacent a rear side of the first decorative item, opposite the harness.

11. A child safety device for tethering a child to an adult, the device comprising:
an attachment mechanism for securement about a torso of the child;
a first decorative item secured to the attachment mechanism for disguising the attachment mechanism;
an anchor for being carried by the adult;
a tether having a first end coupled to the attachment mechanism and a second end coupled to the anchor; and
a second decorative item attached to the anchor for disguising the anchor;
the attachment mechanism comprising a harness including shoulder straps for extending over the shoulders of the child.

12. The device according to claim 11 wherein the attachment mechanism includes a reel for winding the tether thereon, the reel being disguised by the first decorative item and the reel being carried by the harness for positioning adjacent a back of the child.

13. The device according to claim 12 wherein the reel is biased in a winding direction for winding the tether onto the reel and wherein there is provided a lock mechanism which selectively restricts rotation of the reel in the winding direction.

14. The device according to claim 13 wherein there is provided a release button for selectively releasing the lock mechanism, the release button being located adjacent a rear side of the first decorative item, opposite the harness.

15. The device according to claim 12 wherein the second decorative item blends with the first decorative item and the tether is fully covered in a retracted position.

16. The device according to claim 11 wherein the first decorative item is plural times larger than the second decorative item.
